(19) United States
(12) Patent Application Publication
(10) Pub. No.: US 2024/0154501 A1
(43) Pub. Date: May 9, 2024

(54) MOTOR UNIT

(71) Applicant: YAMAHA HATSUDOKI KABUSHIKI KAISHA, Iwata-shi (JP)

(72) Inventors: Takuro KAMICHIKA, Shizuoka (JP); Shinichi KUROSAWA, Shizuoka (JP); Shogo TANINO, Shizuoka (JP)

(21) Appl. No.: 18/542,822

(22) Filed: Dec. 18, 2023

Related U.S. Application Data
(63) Continuation of application No. PCT/JP2022/014120, filed on Mar. 24, 2022.

(30) Foreign Application Priority Data
Jun. 21, 2021 (JP) 2021-102790

(51) Int. Cl. H02K 9/26; H02K 7/116; H02K 9/19

(52) U.S. Cl. CPC H02K 9/26; H02K 7/116; H02K 9/19

(57) ABSTRACT

A motor unit includes a motor and a speed reducer. The motor includes a case including a stator housing, a first motor cover, and a second motor cover. A rotor including a rotor shaft, and a stator including a stator core and a stator coil are provided in the case. An oil filter is provided on an outer surface of the first motor cover. When viewed axially along the rotor shaft, at least a portion of a lower half of the oil filter overlaps with an upper half of the stator core. The speed reducer includes an oil reservoir, and is on a side of the first motor cover. At least one oil pump is provided on an outer surface of the speed reducer.

### CROSS REFERENCE TO RELATED APPLICATIONS

This application claims the benefit of priority to Japanese Patent Application No. 2021-102790 filed on Jun. 21, 2021 and is a Continuation Application of PCT Application No. PCT/JP2022/014120 filed on Mar. 24, 2022. The entire contents of each application are hereby incorporated herein by reference.

### BACKGROUND OF THE INVENTION

### 1. Field of the Invention

The present invention relates to motor units, and more specifically to motor units used in electric vehicles.

### 2. Description of the Related Art

As an example which is pertinent to conventional techniques of this kind, JP-A 2019-154115 discloses a rotating electrical machine. The rotating electrical machine includes a cooling medium path in which a cooling medium for cooling a stator flows, and a cooling medium filter provided in the path of the cooling medium to remove contamination from the cooling medium. The cooling medium filter is installed on a top side of a case which houses the stator.

JP-A 2019-154115 does not compactly configure the rotating electrical machine.

### SUMMARY OF THE INVENTION

Therefore, preferred embodiments of the present invention provide motor units that are compact.

According to a preferred embodiment of the present invention, a motor unit which includes a case including a stator housing, a first motor cover at an output end of the stator housing, and a second motor cover at a non-output end of the stator housing; a rotor inside the case and including a rotor shaft; a stator inside the case and including a stator core radially outside the rotor, and a stator coil in the stator core; and an oil filter on an outer surface of the first motor cover to filter oil to be supplied into the case; wherein at least a portion of a lower half of the oil filter overlaps with an upper half of the stator core when viewed axially along the rotor shaft.

In a preferred embodiment of the present invention, the oil filter is provided on the outer surface of the first motor cover so that at least a portion of the lower half of the oil filter overlaps with the upper half of the stator core when viewed axially along the rotor shaft. This makes it possible to provide the oil filter on the first motor cover at a higher position than the center, i.e., above the center, of the stator core by utilizing an empty space that does not interfere with other portions of the motor unit. Therefore, it is possible to make the motor unit compact.

Preferably, the motor unit further includes a speed reducer on a side of the first motor cover to slow rotation of the rotor and including an oil reservoir to store oil from the case, and an oil pump on an outer surface of the speed reducer to discharge oil out of the oil reservoir. In this case, since the oil pump to discharge oil out of the oil reservoir of the speed reducer is provided on the outer surface of the speed reducer, it is possible to make the motor unit compact, including the oil pump.

Further preferably, the speed reducer further includes an output shaft parallel or substantially parallel to the rotor shaft; and with a line segment connecting a center of the rotor shaft and a center of the output shaft being called a reference line, a perpendicular line perpendicular to the reference line and extending through the center of the rotor shaft being called a first perpendicular line, and a perpendicular line perpendicular to the reference line and extending through the center of the output shaft being called a second perpendicular line; when viewed axially along the rotor shaft, at least a portion of the oil filter overlaps with a region surrounded by the reference line, the first perpendicular line, and the second perpendicular line. In this case, the region surrounded by the reference line, the first perpendicular line, and the second perpendicular line when viewed axially along the rotor shaft is often left as an empty space. Therefore, by providing the oil filter in such a way that at least a portion of the oil filter overlaps with this region, it becomes possible to make an effective use of the empty space without interfering with other portions of the motor unit, and to make the motor unit compact.

Further, preferably, the oil filter is at a higher position than the output shaft. In this case, it is possible to make the motor unit compact without interfering with the output shaft of the speed reducer.

Preferably, the oil filter is at a higher position than the rotor shaft. In this case, it is possible to make the motor unit compact without interfering with the rotor shaft of the rotor.

Further preferably, a center of the oil filter is at a higher position than an outer circumferential surface of the stator coil. In this case, it is possible to supply oil easily onto the stator coil inside the case via the oil filter.

Further, preferably, the motor unit further includes an external pipe outside the stator housing, including an outward oil path to supply oil from the oil filter into the case, and held by the first motor cover and the second motor cover. In this arrangement, at least a portion of the oil filter overlaps with the external pipe when viewed axially along the rotor shaft. In this case, the region outside the stator housing where the external pipe is provided and a region adjacent thereto are often left as empty spaces. Therefore, by providing the oil filter in such a way that at least a portion of the oil filter overlaps with the external pipe when viewed axially along the rotor shaft, it becomes possible to make an effective use of the empty space without interfering with other portions of the motor unit, and to make the motor unit compact.

Preferably, the oil filter includes an oil discharge port at an end of the oil filter facing the first motor cover, and the first motor cover includes an oil path to connect the oil discharge port and the outward oil path of the external pipe. In this case, it is possible to supply oil smoothly to the outward oil path of the external pipe from the oil discharge port provided at the end of the oil filter which faces the first motor cover via the oil path of the first motor cover.

It should be noted here that in preferred embodiments of the present invention, “output end of the stator housing” refers to an axial end of the stator housing from which the motor output is taken off.

“Non-output end of the stator housing” refers to an axial end of the stator housing from which the motor output is not taken off (an axial end on a side away from the output end).

According to preferred embodiments of the present invention, a motor unit is obtained which is compact.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front perspective view which shows a motor unit according to a preferred embodiment of the present invention.

FIG. 2 is a rear perspective view which shows the motor unit in FIG. 1.

FIG. 3 is a right side view which shows the motor unit in FIG. 1.

FIG. 4 is a left side view which shows the motor unit in FIG. 1.

FIG. 5 is an illustrative sectional view which shows the motor unit in FIG. 1.

FIG. 6 is a plan view which shows a gasket of the motor unit.

FIG. 7 is a schematic illustration which shows oil paths in the motor unit.

### DETAILED DESCRIPTION OF THE PREFERRED EMBODIMENTS

Hereinafter, preferred embodiments of the present invention will be described with reference to the drawings.

A motor unit 10 according to a preferred embodiment of the present invention is suitably applied to an electric vehicle. The terms front and rear, left and right, and up and down used in the preferred embodiments of the present invention are defined based on a direction in which a rotor 40 (which will be described below) extends in a left-right direction, and a direction from a motor 12 (which will be described below) toward an inverter 16 (which will be described below) extends in a rearward direction. In the drawings, “Fr” indicates forward, “Rr” indicates rearward, “R” indicates rightward, “L” indicates leftward, “U” indicates upward, and “Lo” indicates downward.

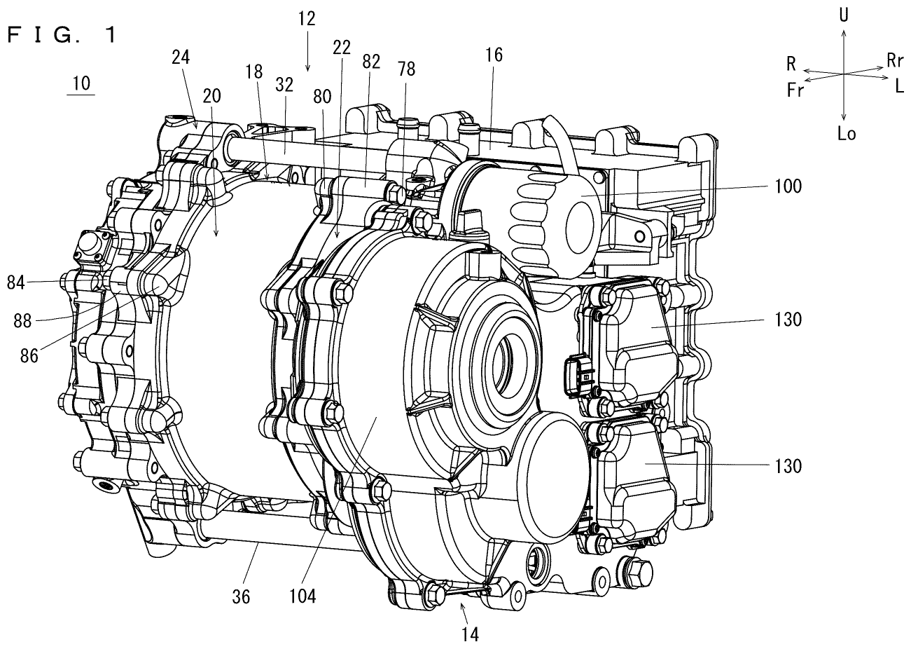

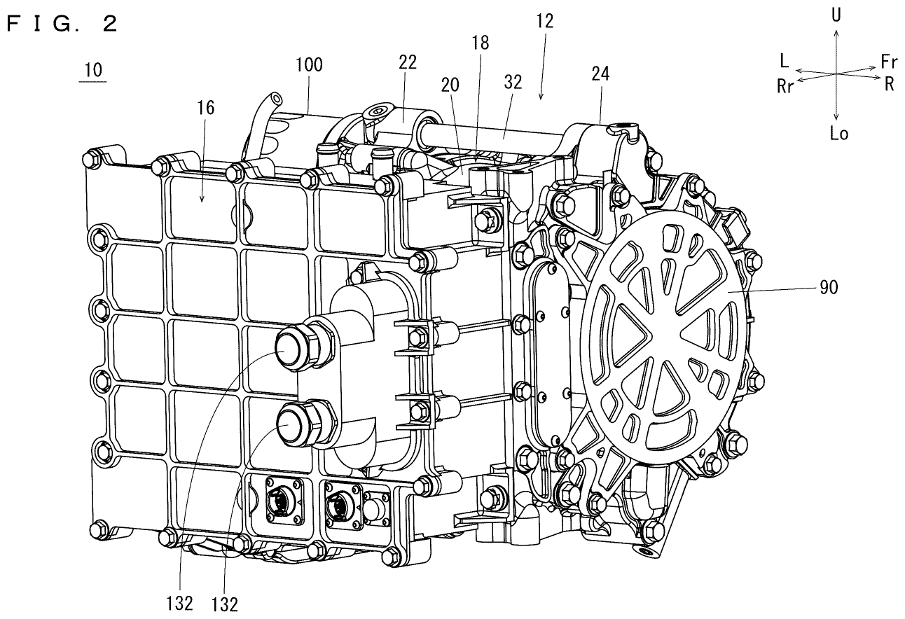

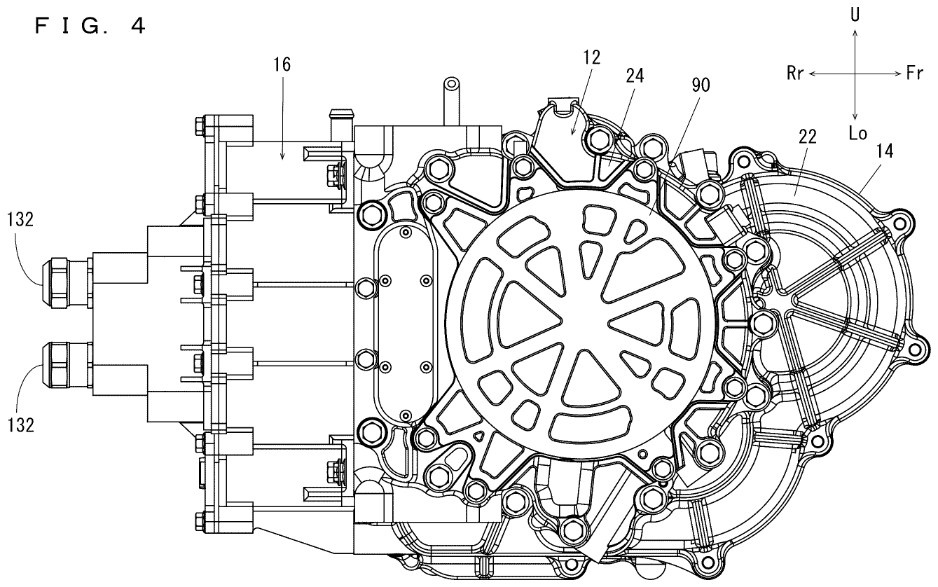

Referring to FIG. 1 through FIG. 4, the motor unit 10 is a mechatronic integrated unit including the motor 12, a speed reducer 14, and an inverter 16. The speed reducer 14 is provided on a side (left side in the present preferred embodiment) of the motor 12, while the inverter 16 is provided behind the motor 12 and the speed reducer 14.

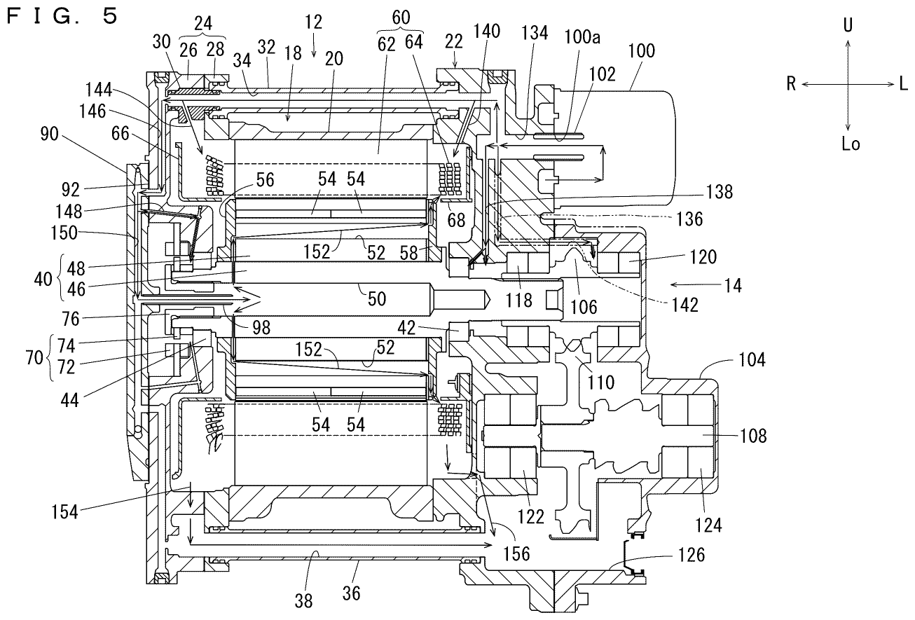

Referring also to FIG. 5, the motor 12 includes a case 18. The case 18 has a three-tier structure, and includes a stator housing 20, a first motor cover 22 provided at an output end of the stator housing 20, and a second motor cover 24 provided at a non-output end of the stator housing 20. The second motor cover 24 includes a cover main body 26 and a pipe holder 28 attached to the cover main body 26. A branched portion 30 is provided between the cover main body 26 and the pipe holder 28.

Outside the stator housing 20, a first external pipe 32 is held by the first motor cover 22 and the second motor cover 24. The first external pipe 32 is separate from the stator housing 20, located slightly spaced away from the stator housing 20, and sandwiched by the first motor cover 22 and the second motor cover 24. The first external pipe 32 includes an outlet end that is held by the pipe holder 28 and is connected with the branched portion 30. Inside the first external pipe 32, an outward oil path 34 extends between the first motor cover 22 and the second motor cover 24. Outside the stator housing 20 at a position lower than the first external pipe 32, a second external pipe 36 is held by the first motor cover 22 and the second motor cover 24. The second external pipe 36 is separate from the stator housing 20, located slightly spaced away from the stator housing 20, and sandwiched by the first motor cover 22 and the second motor cover 24. The second external pipe 36 includes an inlet end that is held by the pipe holder 28. Inside the second external pipe 36, a return oil path 38 extends between the first motor cover 22 and the second motor cover 24. The return oil path 38 is provided at a lower position than the outward oil path 34. Preferably, the outward oil path 34 has a smaller cross sectional area than the return oil path 38. In other words, an inner diameter of the first external pipe 32 is preferably smaller than an inner diameter of the second external pipe 36.

The rotor 40 is provided inside the case 18. The rotor 40 is held rotatably by the first motor cover 22 and the second motor cover 24 via motor bearings 42, 44. The rotor 40 includes a rotor shaft 46 and a rotor core 48. The rotor shaft 46 includes an axially extending hollow portion 50. The rotor core 48 includes a plurality of rotor core holes 52 and a plurality of magnets 54. End plates 56, 58 are disposed at two axial ends of the rotor core 48.

Inside the case 18, a stator 60 is provided radially outside the rotor 40. The stator 60 includes a stator core 62 provided radially outside the rotor 40 and is fixed to the stator housing 20, and a stator coil 64 which is wound around the stator core 62. The stator core 62 is fixed to the stator housing 20 by a shrink fit, for example. Coil end covers 66, 68 cover the two axial ends of the stator coil 64, i.e., to cover the coil ends.

Between the second motor cover 24 and the rotor shaft 46, a resolver 70 is provided to detect a rotating angle of the rotor shaft 46. The resolver 70 includes a resolver stator 72 attached to the second motor cover 24, and a resolver rotor 74 attached to the rotor shaft 46. The resolver rotor 74 is fixed to a rear end of the rotor shaft 46 by, for example, a bolt 76 which has a substantially hat-shaped portion.

Referring to FIG. 1, the stator housing 20 and the first motor cover 22 are connected to each other by a plurality of bolts 78, for example. Each bolt 78 is threaded into a boss 80 provided on an output end on an outer circumferential surface of the stator housing 20, and a boss 82 provided on an outer circumferential portion of the first motor cover 22. The stator housing 20 and the second motor cover 24 are connected to each other by a plurality of bolts 84, for example. Each bolt 84 is threaded into a boss 86 provided on a non-output end on an outer circumferential surface of the stator housing 20, and a boss 88 provided on an outer circumferential portion of the second motor cover 24.

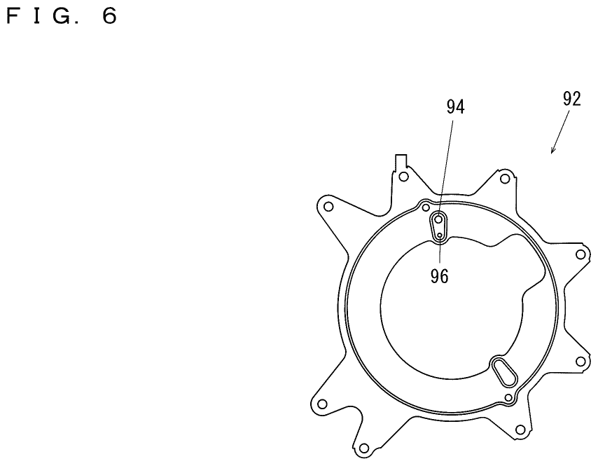

Referring to FIG. 5, a cover 90 is provided on a side of the second motor cover 24. A gasket 92 is located between the second motor cover 24 and the cover 90. Referring to FIG. 6, the gasket 92 has an annular or substantially annular shape, and includes through-holes 94, 96 in communication with the oil paths. A pipe 98 extending into the hollow portion 50 of the rotor shaft 46 is attached at a center portion of the cover 90.

In an outer surface of the first motor cover 22, an oil filter 100 is provided to filter oil which is to be supplied into the case 18. The oil filter 100 is supplied with oil from an oil cooler 158 (which will be described below) provided outside the motor unit 10. The oil filter 100 has a cylindrical or substantially cylindrical outer shape, and includes an oil discharge port 100a at a center of an end facing the first motor cover 22. The oil filter 100 and the first motor cover 22 are connected with each other by a union bolt 102, for example. The union bolt 102 is attached to an inlet-side end of an oil path 134 (which will be described below) of the first motor cover 22, and is inserted into the oil discharge port 100a of the oil filter 100.

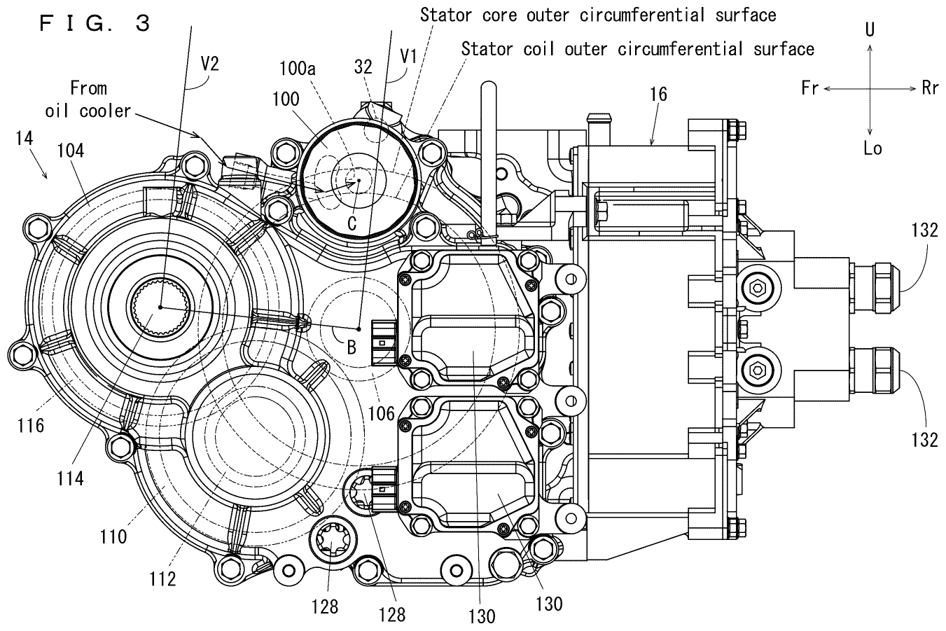

Referring also to FIG. 3, when viewed axially along the rotor shaft 46, at least a portion of a lower half of the oil filter 100 overlaps with an upper half of the stator core 62. The oil filter 100 is at a higher position than the rotor shaft 46 and an output shaft 114 (which will be described below). A center C of the oil filter 100 is at a higher position than an outer circumferential surface of the stator coil 64. When viewed axially along the rotor shaft 46, at least a portion of the oil filter 100 overlaps with the first external pipe 32. Preferably, if the oil filter 100 is a cylindrical filter, the oil discharge port 100a is at the center of the oil filter 100, and the center of the oil filter 100 is at a position higher than the output shaft 114 and the rotor shaft 46. In this case, the layout of the oil filter 100 is compact, and it is possible easily to design the oil path.

The speed reducer 14 is provided on a side (left side in the present preferred embodiment) of the first motor cover 22 to slow rotation of the rotor. The speed reducer 14 includes a gear cover 104 provided on a side of the first motor cover 22. Referring to FIG. 3 and FIG. 5, the gear cover 104 includes an input gear 106, an intermediate shaft 108, intermediate gears 110, 112, an output shaft 114, and an output gear 116. The intermediate shaft 108 and the output shaft 114 are parallel or substantially parallel to the rotor shaft 46. The input gear 106 is attached to a tip portion of the rotor shaft 46, and is supported rotatably by the first motor cover 22 and the gear cover 104 via input gear bearings 118, 120. The intermediate shaft 108 is supported rotatably by the first motor cover 22 and the gear cover 104 via intermediate gear bearings 122, 124. The intermediate gears 110, 112 are both attached to the intermediate shaft 108. The intermediate gear 110 meshes with the input gear 106. The intermediate gear 112 meshes with the output gear 116. The output shaft 114 is supported rotatably by the first motor cover 22 and the gear cover 104 via unillustrated bearings. The output gear 116 is attached to the output shaft 114. With a line segment connecting a center of the rotor shaft 46 and a center of the output shaft 114 being called a reference line B; a perpendicular line perpendicular to the reference line B and extending from the center of the rotor shaft 46 being called a first perpendicular line V1; and a perpendicular line perpendicular to Reference line B and extending from the center of the output shaft 114 being called a second perpendicular line V2; when viewed axially along the rotor shaft 46, at least a portion of the oil filter 100 overlaps with a region surrounded by the Reference line B, the first perpendicular line V1, and the second perpendicular line V2. The gear cover 104 covers an outer surface of the first motor cover 22 to define an oil reservoir 126 that connects to the return oil path 38. In other words, the oil reservoir 126 is inside the speed reducer 14. The oil reservoir 126 is provided with an oil strainer 126a, and stores oil from the case 18 and oil from the gear cover 104.

The gear cover 104 is provided with two oil level gauges 128 to detect an amount of oil inside the oil reservoir 126. Also, the gear cover 104 is provided with two oil pumps 130 to supply oil from inside the oil reservoir 126 to the outside oil cooler 158. In other words, the two oil pumps 130 are provided on an outer surface of the speed reducer 14 to discharge oil to outside the motor unit 10.

The inverter 16 is connected with a battery (not illustrated) via connecting terminals 132, converts a direct current from the battery into an alternating current, and supplies the current to the motor 12.

The motor unit 10 described thus far includes the following oil paths.

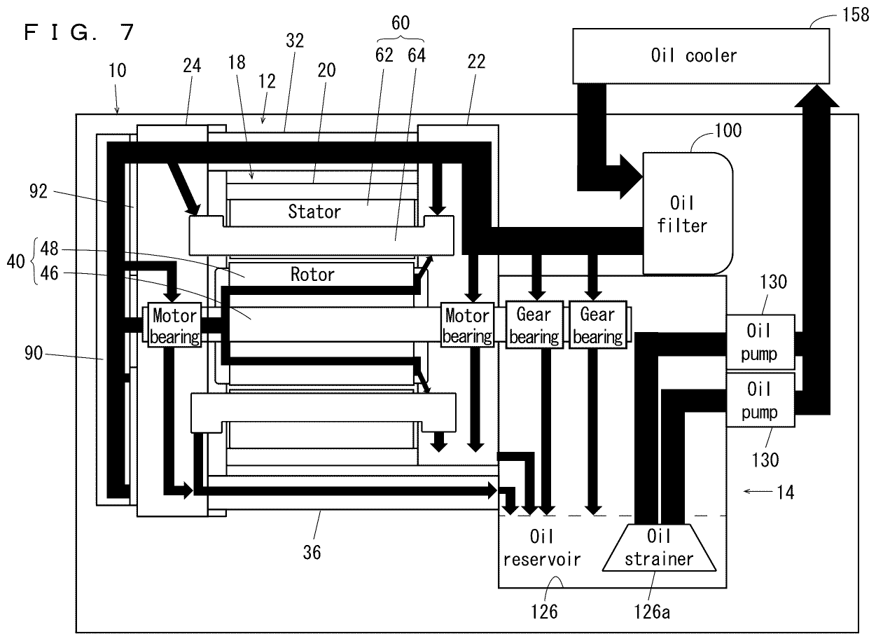

Referring to FIG. 5 and FIG. 7, the first motor cover 22 includes an oil path 134 connected to the outward oil path 34 to supply oil from the oil filter 100 to the outward oil path 34, and oil paths 136, 138, 140 branching from the oil path 134. The oil path 134 connects the oil discharge port 100a of the oil filter 100 with the outward oil path 34 of the first external pipe 32. The oil path 136 connects with an oil path 142 inside the speed reducer 14 to supply oil to the input gear bearing 120. Oil from the oil path 138 is supplied to the motor bearing 42 and the input gear bearing 118. Oil from the oil path 140 is supplied to the coil end of the stator coil 64. The oil is supplied into the case 18 via the oil paths 138, 140. Oil from the oil path 134 flows through the outward oil path 34 and is supplied to the second motor cover 24.

The second motor cover 24 includes oil paths 144, 146, 148. Oil which flows through the outward oil path 34 and is supplied to the second motor cover 24 is divided by the branched portion 30, supplied to the coil end of the stator coil 64 via the oil path 144, and sent toward the cover 90 via the oil path 146. The cover 90 includes an oil path 150. The oil path 150 connects the oil paths 146 and 148 with each other. In other words, the oil path 146 and the oil path 150 communicate with each other via the through-hole 94 of the gasket 92, while the oil path 150 and the oil path 148 communicate with each other via the through-hole 96 of the gasket 92. Therefore, the oil paths 146 and 148 of the second motor cover 24 communicate with each other via the oil path 150 of the cover 90, and oil from the oil path 146 is supplied to the motor bearing 44 and its surroundings via the oil paths 150, 148. Also, the oil path 150 connects, via the pipe 98, the hollow portion 50 of the rotor shaft 46 and the rotor core holes 52 with an oil path 152 which leads to the coil end of the stator coil 64. Therefore, oil from the oil path 150 is supplied to the coil end of the stator coil 64 via the oil path 152. The oil from the outward oil path 34 is supplied into the case 18 via the second motor cover 24 and the cover 90.

Oil which is supplied to the coil end of the stator coil 64 is then supplied to the oil reservoir 126 via an oil path 154 and the return oil path 38, or via an oil path 156 of the first motor cover 22. Oil inside the oil reservoir 126 is sucked by the two oil pumps 130 through the oil strainer 126a, and supplied to the oil cooler 158. The oil cooler 158 cools the oil, and then the oil is returned to the oil filter 100.

In a preferred embodiment, the first external pipe 32 corresponds to the external pipe.

According to the motor unit 10 as described thus far, the oil filter 100 is provided on the outer surface of the first motor cover 22 so that at least a portion of the lower half of the oil filter 100 overlaps with the upper half of the stator core 62 when viewed axially along the rotor shaft 46. This makes it possible to provide the oil filter 100 on the first motor cover 22 at a higher position than the center, i.e., above the center, of the stator core 62 by utilizing an empty space that does not interfere with other members of the motor unit 10. Therefore, it is possible to make the motor unit 10 compact.

The oil pumps 130 to discharge oil out of the oil reservoir 126 of the speed reducer 14 is provided on the outer surface of the speed reducer 14. Therefore, it is possible to make the motor unit 10 compact, including the oil pumps 130.

The region surrounded by the reference line B, the first perpendicular line V1, and the second perpendicular line V2 when viewed axially along the rotor shaft 46 is often left as an empty space. Therefore, by providing the oil filter 100 in such a way that at least a portion of the oil filter 100 overlaps with this region, it becomes possible to make effective use of the empty space without interfering with other members, and to make the motor unit 10 compact.

Since the oil filter 100 is at a higher position than the output shaft 114, it is possible to make the motor unit 10 compact without interfering with the output shaft 114 of the speed reducer 14.

Since the oil filter 100 is at a higher position than the rotor shaft 46, it is possible to make the motor unit 10 compact without interfering with the rotor shaft 46 of the rotor 40.

Since the center C of the oil filter 100 is at a higher position than the outer circumferential surface of the stator coil 64, it is possible to supply oil easily onto the stator coil 62 inside the case 18 via the oil filter 100.

The region outside the stator housing 20 where the first external pipe 32 is provided, and a region adjacent thereto are often left as empty spaces. Therefore, by providing the oil filter 100 in such a way that at least a portion of the oil filter 100 overlaps with the first external pipe 32 when viewed axially along the rotor shaft 46, it becomes possible to make an effective use of the empty space without interfering with other portions, and to make the motor unit 10 compact.

It is possible to supply oil smoothly to the outward oil path 34 of the first external pipe 32 from the oil discharge port 100a provided at the end of the oil filter 100 which faces the first motor cover 22 via the oil path 134 of the first motor cover 22.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor unit comprising:
a case including a stator housing, a first motor cover at an output end of the stator housing, and a second motor cover at a non-output end of the stator housing;
a rotor inside the case and including a rotor shaft;
a stator inside the case and including a stator core radially outside of the rotor, and a stator coil in the stator core; and
an oil filter on an outer surface of the first motor cover to filter oil to be supplied into the case; wherein
at least a portion of a lower half of the oil filter overlaps with an upper half of the stator core when viewed axially along the rotor shaft.

2. The motor unit according to claim 1, further comprising:
a speed reducer on a side of the first motor cover to slow rotation of the rotor and including an oil reservoir to store oil from the case; and
an oil pump on an outer surface of the speed reducer to discharge oil out of the oil reservoir.

3. The motor unit according to claim 2, wherein
the speed reducer further includes an output shaft parallel or substantially parallel with the rotor shaft; and
with a line segment connecting a center of the rotor shaft and a center of the output shaft being called a reference line, a perpendicular line perpendicular to the reference line and extending through the center of the rotor shaft being called a first perpendicular line, and a perpendicular line perpendicular to the reference line and extending through the center of the output shaft being called a second perpendicular line;
at least a portion of the oil filter overlaps with a region surrounded by the reference line, the first perpendicular line, and the second perpendicular line when viewed axially along the rotor shaft.

4. The motor unit according to claim 3, wherein the oil filter is higher than the output shaft.

5. The motor unit according to claim 1, wherein the oil filter is higher than the rotor shaft.

6. The motor unit according to claim 1, wherein a center of the oil filter is higher than an outer circumferential surface of the stator coil.

7. The motor unit according to claim 1, further comprising:
an external pipe outside the stator housing, including an outward oil path to supply oil from the oil filter into the case, and held by the first motor cover and the second motor cover; wherein
at least a portion of the oil filter overlaps with the external pipe when viewed axially along the rotor shaft.

8. The motor unit according to claim 7, wherein
the oil filter includes an oil discharge port at an end of the oil filter facing the first motor cover; and
the first motor cover includes an oil path extending between the oil discharge port and the outward oil path of the external pipe.
